(19) United States
(12) Patent Application Publication
(10) Pub. No.: US 2013/0073384 A1
(43) Pub. Date: Mar. 21, 2013

(54) System and method for forced delivery of advertisement over Internet media streaming

(71) Applicant: Haifeng Qiu, Richmond (CA)

(72) Inventor: Haifeng Qiu, Richmond (CA)

(21) Appl. No.: 13/237,943

(22) Filed: Sep. 21, 2011

(51) Int. Cl. G06Q 30/02

(52) U.S. Cl. 705/14.49; 705/14.73

(57) ABSTRACT

A method and system for forced delivery and reception of multimedia advertisement before or during playback of requested steaming content from a communications system is disclosed. The system includes an application launched from a device, in communication with a host server that provides streaming multimedia contents, which is responsive to user inputs. The host server includes software that can deliver advertisement before or during playback of desired content, as well as receive and verify user response to the ad-related questionnaire after the advertisement was viewed. Upon verification of the desired response from user, the server will play the content. Otherwise, content will not be played. This system and method increases the effectiveness of delivered advertisement, due to mandatory viewing and understanding of the advertised message, thus generating greater revenue. Practical application, in which subsidized or free streaming content is made possible, is also disclosed.

### FIELD OF THE INVENTION

This application relates to a method for forced advertising over Internet media streaming. Specifically, this application relates to collecting user feedback after showing an advertisement, and using that user input to verify if user was effectively receiving the advertisement.

### BACKGROUND OF THE INVENTION

In recent years, online multimedia streaming are becoming more and more popular, as a result of improved communications infrastructure. Bandwidth and transfer speed on both landline Internet and wireless data network have been greatly increased, and are expected to improve constantly. End users are now enjoying very rich multimedia contents over the Internet, such as music, TV episodes, and movies. Companies have made available online full length and high quality clips, movies and songs, which users can stream in near real-time on their devices. These companies or brands include YouTube, Netflix, Hulu, and Pandora.

Streaming or media streaming is a technique for transferring data so that it can be processed as a steady and continuous stream. Streaming technologies are becoming increasingly important with the growth of the Internet because most users do not have fast enough access to download large multimedia files quickly. With streaming, the client browser or plug-in can start displaying the data before the entire file has been transmitted, thus enabling near real-time playback of the media.

As the audience of these streaming contents grows, so too has the need for advertisement. Streaming technology requires high-speed data transmission, which demands investment in infrastructure. Furthermore, if the content being played is copyrighted, such as full-length movie, TV, or music, the provider for such streaming service will pay licensing fee as well. These costs are normally covered by advertisement, a fee charged per month or per use, or a combination of both.

There are various forms of online advertisements, such as text, graphic, audio, or video ads. A multimedia ad can contain a combination of these.

The problem with traditional online advertisement is that it can be easily circumvented. The user can choose to close down the ad window, or simply ignore the commercial message if it's within the same viewing window. For example, the end user can simply sit and wait until an audio or video ad is over, while doing something else entirely, without listening or watching the message in the ad.

This problem results in poor ad performance, and in turn causes lower ad revenue. It is the main reason that current advertising method is inadequate in providing subsidized or free streaming of copyrighted content, such as full-length music, TV, and movies.

### SUMMARY OF THE INVENTION

This application is a method and system for forced delivery and reception of multimedia advertisement (such as text, graphic, audio, or video ads) before and/or during the playback of requested steaming content from a communications system, such as the Internet. The system includes an application launched from a device, such as a computer, a smart phone, an Internet capable TV or media player, in communication with a host server that provides streaming multimedia contents, which is responsive to user inputs. The host server includes software that can deliver advertisement before and/or during the playback of desired content, as well as receive and verify user response to ad-related questionnaire after the advertisement was viewed. Upon verification of the desired response from user, the server will commence or resume playback of the content. Otherwise, desired content will not be played. This system and method therefore greatly increases the effectiveness and penetration of delivered advertisement, due to mandatory viewing and understanding of the advertised message, thus generating much higher revenue for the content provider compared to the current advertising methods.

Practical application of this system and method can be used to provide subsidized or even free streaming content (such as copyrighted music, TV, and movies) to the end user.

### BRIEF DESCRIPTION OF THE DRAWINGS

FIG. 1 is a schematic view of the structure of a content streaming system over the Internet.

FIG. 2 is a flowchart illustrating the process and method for requiring end user to view ads before and/or during the media streaming, and how to use user response to determine if playback can continue.

FIG. 3 is a sample screenshot demonstrating the questionnaire that requires user to input correct feedback so that media playback can continue.

FIG. 4 is a sample screenshot demonstrating a modified system, in which a survey instead of a questionnaire is displayed after the media playback.

FIG. 5 is a sample screenshot demonstrating a modified system, in which user information is collected for marketing purposes.

FIG. 6 is a flowchart illustrating the process in which an advertisement is selected to play, based on criteria stored in the ad database.

FIG. 7 is a sample database table demonstrating the data structure of the advertisement database, in which questionnaire and answers, as well as ad customization info, are stored.

FIG. 8 is a diagram illustrating the various input methods to playback devices, by which user inputs are collected.

FIG. 9 is a sample number pad found on most phones or remote control units, on which users can input text.

FIG. 10 is a flowchart illustrating the advertisement confirmation method (forced advertisement) in general.

### DETAILED DESCRIPTION OF THE INVENTION

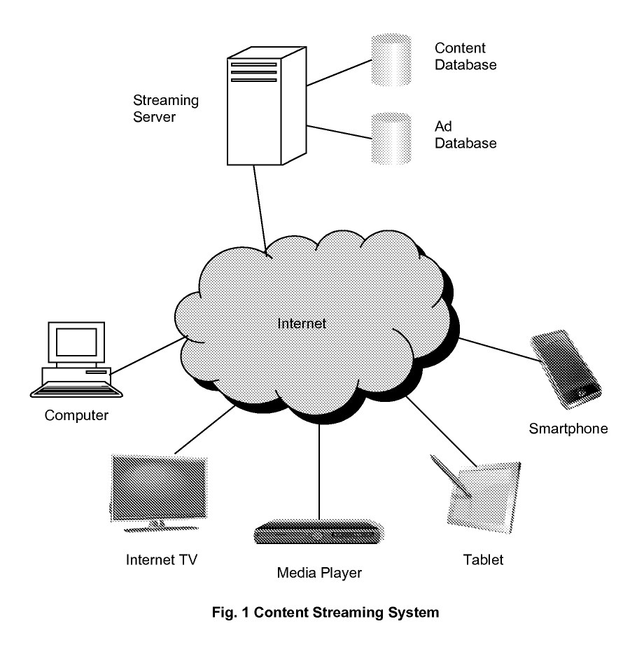

The system for streaming multi-media contents over the Internet is shown schematically in FIG. 1. This system includes a server that can provide a constant stream over the Internet to multiple end users simultaneously. The server stores media contents in a database, where they are played on demand. The server also stores advertisement material in a database, including ads themselves as well as the questionnaires and the correct responses to them. Contents and ads are streamed over the Internet, and received by various user devices, such as computers (PC or Mac), smartphones (iphone, android phone, blackberry, etc.), tablets (iPad or android tablet), media players (Internet capable DVD player, standalone media player/receiver, Internet capable gaining console, etc.), or Internet capable TVs. Questionnaires will be received by the end user, and the responses sent back to the server via the Internet and verified against the correct answers stored in the database.

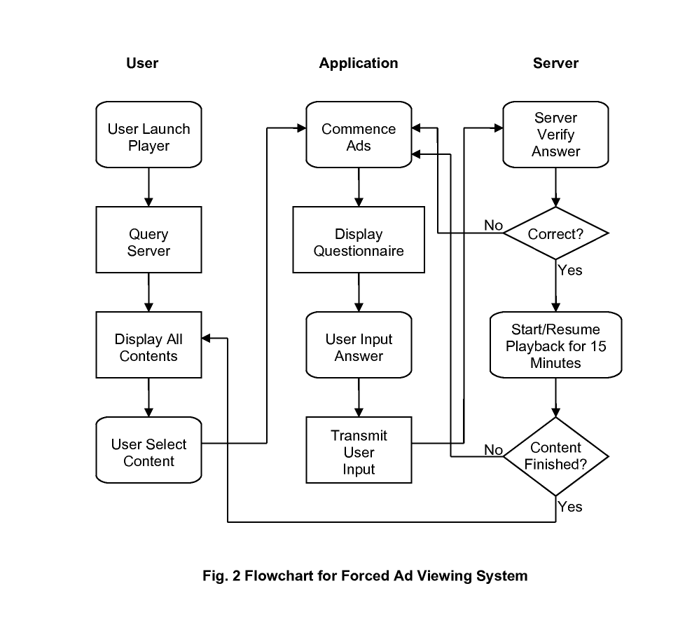

The end users shown in FIG. 1 stream the contents from the content provider's server. These receiving devices use various types of software to stream the contents, such as an Adobe Flash Player, HTML 5 media player, or any custom-made application for a computer or a mobile device. This software is programmed to not only stream media contents, but also send feedback to the provider's server. This allows the proposed system/method to deliver forced advertisement viewing before or during the playback of the desired content. Without the end user's mandatory participation and correct response to the questionnaire, the playback won't commence. A detailed flowchart illustrated in FIG. 2 shows this process.

As seen in FIG. 2, at the user end, the proper media player is launched. The server will provide a list of all available media contents, sorted with various methods (such as by genre or alphabetically) to allow easy browsing. End user will then select the desired content, and the choice will be sent via the Internet to the server.

On the media player application, the advertisement will commence, streamed from the server. Advertisement can be in the form of simple text with or without HTML links, graphic ad with or without HTML links, audio, or video.

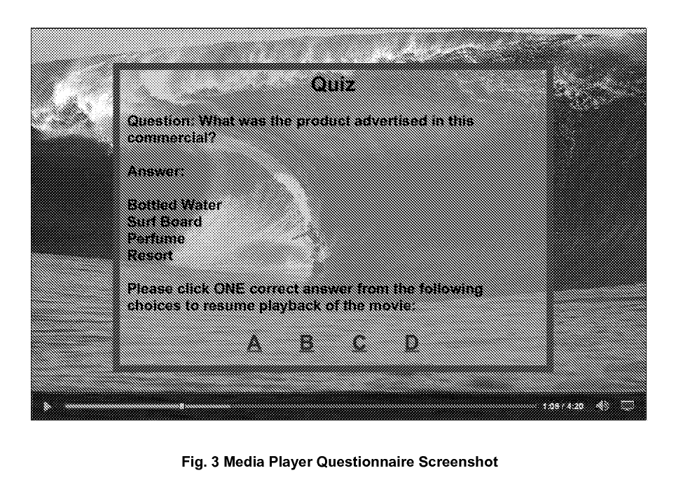

After the advertisement is finished, the server will provide a questionnaire to the end user. This questionnaire is stored in the ad database, uniquely designed for the ad that has just been played. The answer to the questionnaire is directly linked to the commercial message embedded in the advertisement, and impossible to guess without viewing and fully understanding the ad. FIG. 3 shows an example of such questionnaire on the screen of the media player.

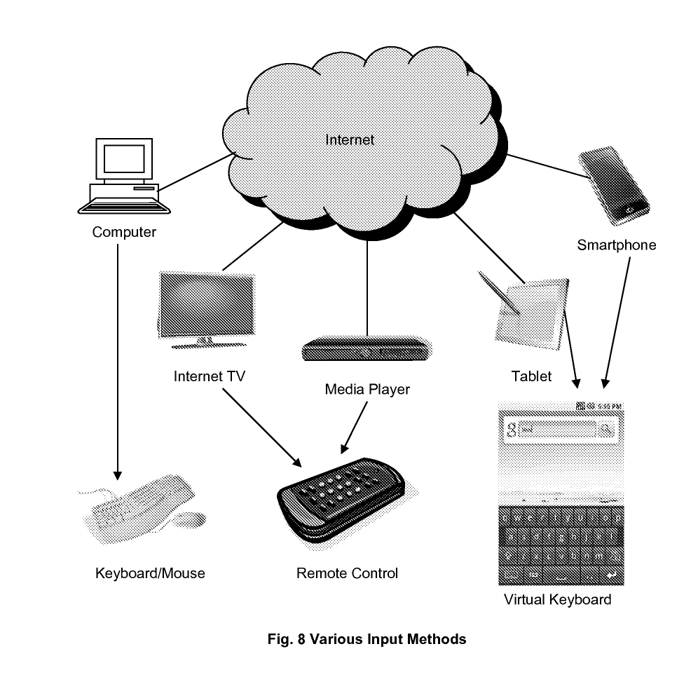

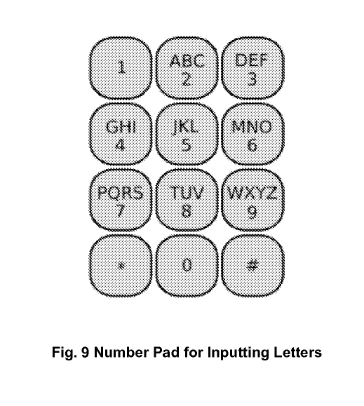

End users will then input the correct answer via the device's input method. The input methods vary from device to device. FIG. 8 illustrates the various input methods to playback devices. The complexity of the input method will dictate the programming of the questionnaire. For example, for an Internet capable TV or gaming console, a remote control, instead of a keyboard is present. Therefore, input of letters will utilize a similar method to inputting text on a cellphone number pad (also known as the “multi tap” method). This is illustrated in FIG. 9.

Once a user input is detected on the user device, the response is sent back to server over the Internet, where it is compared with the correct answer stored in the ad database. If the answer is correct, then the playback of desired media content will continue for a specified period of time. In the example illustrated in FIG. 2, playback will continue for 15 minutes, before another commercial interruption is due. Depending on the design by content provider, this interruption is optional.

If the answer to the questionnaire is incorrect, the server will provide another ad so that the end user has another chance to input the correct answer.

After the 15 minutes of playback, media content will be paused. Unless the content is finished, another commercial will be played, and response recorded and verified to resume playback.

This proposed system/method is far superior to conventional online advertising in many aspects.

1. Advertisement is integrated with actual media content in a more natural way. The ad can now be designed in the same format as the desired content. For example, an end user wishing to listen to songs online can now listen to audio ads and respond to it, in order to continue listening, compared to encountering banner or text ads on a webpage. Advertisement is also displayed in the same media player, instead of outside on a webpage.

2. The advertisement is impossible to avoid, thus effectiveness of the ad is greatly improved. Unlike all other conventional online advertising methods, this proposed method requires complete attention and responsiveness from the end user, and is impossible to ignore. Any attempt to avoid viewing the ads will result in desired media content not being played.

3. The advertisement gets much better reception. End users are required to understand and remember all details of the commercial message, in order to answer the question at the end of the ad. Since it is impossible for the user to guess the question before viewing the ad, there is no incentive to skip any part of the commercial ad.

4. Multiple ads can be played during the single media stream. Ad sessions can be played at the beginning of playback and during multiple commercial interruptions. Depending on the design of content provider, each ad session can have one single ad or multiple ads. This method will multiply the number of ads received by the end user for any streaming activity.

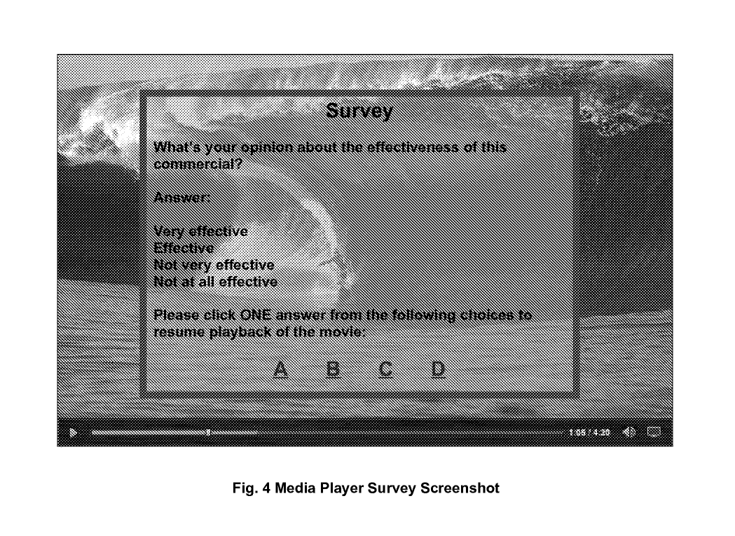

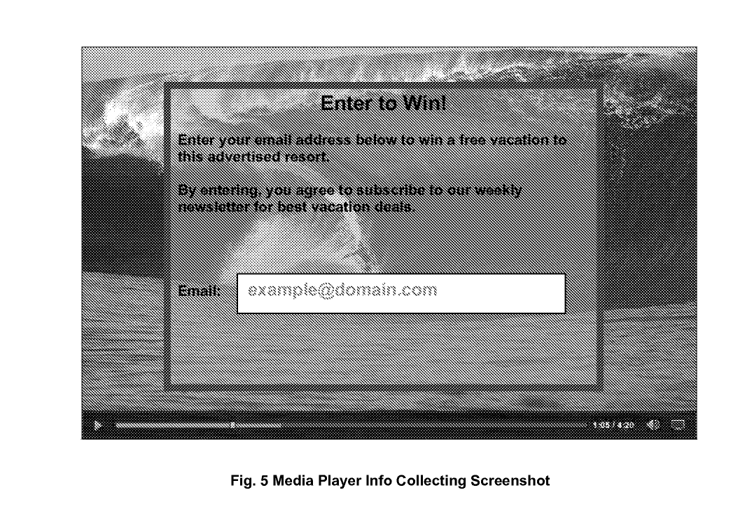

5. Besides simply delivering a commercial message, this system will also give advertisers valuable feedback. The questionnaire part of the system can easily be modified to serve other purposes. For example, instead of inputting correct answer for tie questionnaire, end users can be required to complete a survey, in which there is no correct answer, although an answer is required to continue the playback. The results will be stored on the server and later forwarded to the advertiser for market research purposes. This is demonstrated in FIG. 4. In another example, the system is used to collect user information, such as email addresses, for advertiser's future marketing purposes. This is demonstrated in FIG. 5.

6. This proposed advertising method will generate much higher revenue for the content provider. Due to the high effectiveness and reception of the ads, advertisers will likely pay a higher fee to deliver the commercial message. This collected fee can be used to pay for licensing/royalty costs of the media contents. In practical application, a deeply subsidized or even free system for streaming copyrighted content (such as full length movies, TV episodes, and music) is possible.

Depending on the requirement of advertisers, the advertisement played during the streaming can be highly customized. Because the media player on the user's end is programmed to send information back to the server, the ad delivering software on the server can decide which ad to play for a specific end user. A practical application of this function is to collect IP address of the user, thus determining user's location, and then play the ad from a local advertiser just for this customer. Another example is for the server software to suggest an advertisement based on the genre of the content that is currently being played to the user, such as playing a sports drink commercial to an end user that's watching a sports movie.

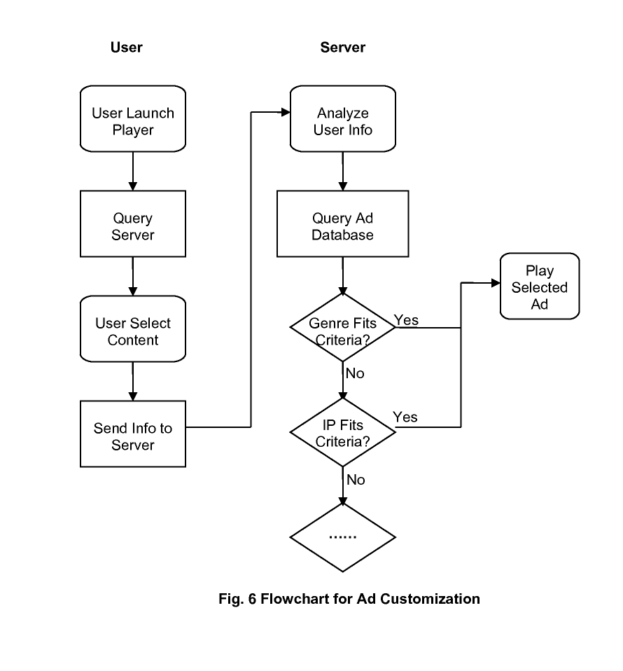

FIG. 6 shows the process of determining which ad to display based on the information collected from the end user. After the user launches the media player, and selects the desired content to stream, the media player will send user information back to the content server. The server analyzes this info, and queries the ad database to try to find a matching advertisement to play. For example, it will try to match the genre of the content being played with the genre preferred by the advertisers as stored in the database; the advertisement that fits this criterion will be played. If none found, the server will query alternative criteria, such as matching IP address of the end user with the location preferred by the advertiser, then play it.

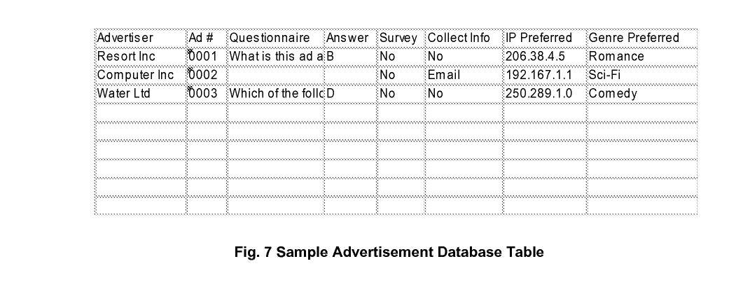

Customization of the ad delivery can be achieved with the help of ad database stored on the server. FIG. 7 illustrates a sample database table that contains the necessary information. In this database, each advertisement has its own questionnaire with correct answer, or a survey or information collecting box, as well as preferred IP address range, or preferred genre of the movie played.

Practical application of this improved method of advertising can also be used to serve broader purposes than just forced media advertising. The forced advertising system shown in FIG. 2 can be modified for other uses based on the advertisement confirmation concept. For example, instead of using the questionnaire to confirm the user participation, and determining if playback can continue, the server can continue playback regardless of the correctness. However, if the answer is correct, the end user will be rewarded with points. These reward points can later be redeemed for free content streaming or merchandise, depending on the services provided by the content provider.

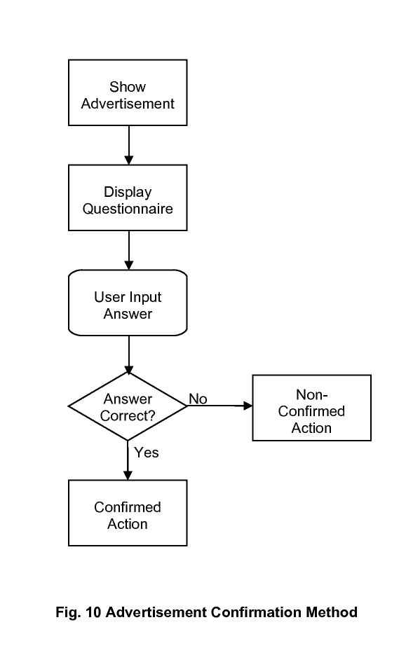

The advertisement confirmation concept can also be used on any type of online advertisement, no just limited to content streaming. FIG. 10 is a flowchart illustrating the concept of this advertisement confirmation method. After an advertisement is shown, the end user is given a questionnaire to answer. The questions are directly related to the advertised message, and impossible to guess without understanding the advertisement. Once the correct answer is given, the reception of the ad is confirmed. The system will then take the action predetermined by the service provider, such as continuing playback, or giving reward points. If desired answer is not given, the system will take the non-confirmed action, such as playing another ad, or not giving points. The effectiveness of this ad confirmation method is far greater than any online advertisement method currently in use.

What is claimed is:

1. In a media streaming system that communicates over the Internet, with a media playback device to stream multimedia content, a method for forcing the display of advertisement material by the playback device before or during playback of the actual content by the playback device, the method comprising the acts of:
a. displaying, on said playback device, a screen that shows a questionnaire, which is uniquely linked to the advertisement material just played, for which a correct answer is required;
b. collecting and transmitting, from said playback device to the server that is providing the streaming content, the user input for the correct answer to the questionnaire;
c. determining, at said server, if the request for playback of actual content should continue or be denied, based on comparison of said user input and the correct answer stored in a database on said server.

2. In an online advertisement system, a method for confirming the user reception of the advertisement, comprising the acts of:
a. displaying, after an advertisement is shown, a questionnaire that is uniquely linked to the advertised message, for which an answer is impossible to guess without understanding the advertisement;
b. determining, by comparison to the correct answer, if the answer to the questionnaire given by the user is the correct one;
c. confirming, based on the comparison result, if said end user has viewed and fully understood the advertised message, and then take predetermined action.

3. The method of claim 1, wherein software on said server denies the playback request if the user input to the questionnaire is incorrect, whereby circumvention of the advertisement is prevented.

4. The method of claim 1, wherein said advertisement is designed in the same format as the streaming content, and played in the same media player window.

5. The method of claim 1, wherein a programming language is used in said media player to allow display of the questionnaire after the advertisement, and collect answers to the questionnaire, then transmit the user input to said server.

6. The method of claim 5, wherein a questionnaire is optionally substituted with a survey or an information collecting form.

7. The method of claim 1, wherein an advertisement is inserted at the beginning of said media streaming, and optionally inserted repeatedly after specified intervals between pauses of said media playback.

8. The method of claim 1, where in another advertisement is shown after said end user failed to provide the correct answer to the previous ad's questionnaire, so that another chance will be given to answer the questionnaire correctly.

9. The method of claim 6, wherein the result of survey or information collected during said advertisement session is sent to said server, stored, and later forwarded to the advertiser.

10. The method of claim 1, wherein said server determines which advertisement to send to said end user, based on preference/criteria indicated by the advertiser.

11. The system of claim 1, wherein a number keypad on remote control is used as input method for collecting inputs for said questionnaire from media playback devices without a full keyboard.

12. The system of claim 1, wherein subsidized or free playback of copyrighted media material over the Internet is implemented.
